(19) United States
(12) Patent Application Publication
(10) Pub. No.: US 2025/0348806 A1
(43) Pub. Date: Nov. 13, 2025

(54) MICROTASK PUSH NOTIFICATION FRAMEWORK

(71) Applicant: Wells Fargo Bank, N.A., San Francisco, CA (US)

(72) Inventors: Rajeswaran Govindan, Livermore, CA (US); Margaret Seter Honeycutt, Crockett, CA (US); Wyman Yu, San Francisco, CA (US); Jason V. Biala, Martinez, CA (US); Ryan Lee Hammond, San Jose, CA (US); Dennis E. Montenegro, Concord, CA (US); Christopher Sipanya, San Jose, CA (US); Sergey Yamandiy, Castro Valley, CA (US); Miriam Felecia Clark, San Francisco, CA (US); Jason Huang, San Francisco, CA (US)

(21) Appl. No.: 17/807,647

(22) Filed: Jun. 17, 2022

(51) Int. Cl. G06Q 10/0631

(52) U.S. Cl. CPC G06Q 10/063116; G06Q 10/06312; G06Q 10/06316

(57) ABSTRACT

A method may include accessing a task data structure from a data store; segmenting task components of the task data structure, into a first category of task components and a second category of task components; associating the first category of tasks with a first category of computing devices and the second category of tasks with a second category of computing devices; determining a current computing device of a user; obtaining a classification of the current computing device of the user indicating the current computing device is a part of the first category of computing devices; and: selecting a first task component of the task data structure from the first category of tasks; and presenting a suggested action for the first task component on the current computing device of the user.

### BACKGROUND

Some tasks can be time-consuming, burdensome, and inconvenient, such that addressing them can lead to executive function fatigue. In some cases, this can result in people avoiding addressing tasks or inaccurately completing them. Additionally, many of these tasks are completed using computing devices; however, not all devices are equally suitable for completing a task.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an illustration of components of an application server and client devices, according to various examples.

FIG. 2 illustrates a flowchart showing a method for providing push notifications for microtasks, according to various examples.

FIG. 3 illustrates general components of a push notification framework, according to various examples.

FIG. 4 is a flowchart illustrating a method for presenting suggested actions, according to various examples.

FIG. 5 is a block diagram illustrating an example machine upon which any one or more of the techniques (e.g., methodologies) discussed herein may be performed, according to various examples.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

Throughout this disclosure, electronic actions may be taken by components in response to different variable values (e.g., thresholds, user preferences, etc.). As a matter of convenience, this disclosure does not always detail where the variables are stored or how they are retrieved. In such instances, it may be assumed that the variables are stored on a storage device (e.g., RAM, cache, hard drive) accessible by the component via an API or other program communication method. Similarly, the variables may be assumed to have default values should a specific value not be described. User interfaces may be provided for an end-user or administrator to edit the variable values in some instances.

In various examples described herein, user interfaces are described as being presented to a computing device. Presentation may include transmitting data (e.g., a hypertext markup language file) from a first device (such as a web server) to the computing device for rendering on a display device of the computing device via a rendering engine such as a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples these portions may be displayed on a screen at the same time, in other examples the portions/elements may be displayed on separate screens such that not all of the portions/elements are displayed simultaneously. Unless indicated as such, the use of “presenting a user interface” does not infer either one of these options.

Additionally, the elements and portions are sometimes described as being configured for a certain purpose. For example, an input element may be described as being configured to receive an input string. In this context, “configured to” may mean presentation of a user interface element that is capable of receiving user input. Thus, the input element may be an empty text box or a drop-down menu, among others. “Configured to” may additionally mean computer executable code processes interactions with the element/portion based on an event handler. Thus, a “search” button element may be configured to pass text received in the input element to a search routine that formats and executes a structured query language (SQL) query with respect to a database.

It is common for a user to use task management software to manage a set of “to-dos” the user may wish to accomplish. Additionally, there are often tasks that an application requests a user to perform. For example, consider that a user is using a budgeting application on their personal computer or as part of a web application. As part of the budgeting process, the application may request the user categorize past transactions. Or the user may use goal tracking software where each goal requires a number of subtasks such as entering a title, adding a picture, a budget, etc. Different subtasks may be better suited to different devices. For example, electronically signing a document may be easily done on a laptop and without too much trouble on a large screen smart phone but would be difficult to complete on a smart watch. Other tasks may require the use of a certain input device, such as a camera, that a small form factor device does not have. Additionally, users often have numerous computing devices, but it is not always clear which device is near the user or is currently in use by the user.

Described herein are improvements to electronic task management systems and inter-device communication methods to alleviate the problems discussed above. In doing so technical problems related to knowing which device a user is using, the capabilities of the device, and determining an environmental context of a user, are overcome. As part of the improvements, a novel task data structure is used that segments a task (also referred to a macro task) into a set of component tasks (also referred to as microtasks). These component tasks are not sub-tasks that have been identified by a user as part of a larger task (e.g., as part of buying a car a user might have added a test drive subtask). Instead, the system and methods described herein divide a task into smaller portions such that differing portions of the task may be completed on different devices based on a device form factor, among other criteria.

The systems and methods described herein generally involve providing push notifications regarding microtasks to a small form device, such as a wearable. Tasks are divided up into microtasks that can easily be viewed or addressed on the small form user device. A suggested action corresponding to the microtask can be selected based on the small form device and sent to the user device based on time of day, a user's schedule, a user location, user input, biometric data, other information received from the user device, a combination of these, or the like.

The user device can be any user device, including a personal computer, a tablet, a smartphone, a smartwatch, smart glasses, a smart ring, a smart bracelet, a smart badge, another wearable, or the like, however for the purposes of many examples, the suggested actions (and in some cases the microtasks) are selected for user devices that are small form devices such as wearables. That is, the suggested action or microtask is selected such that it can easily be displayed and addressed on the user's device; for example, the amount of information that can reasonably be displayed and addressed on a small form device such as a smartwatch is different than the amount of information that could reasonably be displayed and addressed on a laptop.

As such, the presently disclosed systems and techniques described herein generally involve presenting quick bits of information to a user on their wearable device or smartphone that may be related to a task, such as, financial goals of the user, financial planning, transactions, account status, setup, or maintenance, purchases, budgets, travel, financial coordination with others, a combination of these, or the like. The suggested action is provided as a push notification that may include one or more selections for the user to select in response to the suggested action.

In some examples, the systems and methods described herein involve determining when to output the push notification with the suggested action based on information received from the user or the user device. For example, a user may set parameters or provide a schedule to indicate when the user is available to handle microtasks. In some example, a user's device may provide sensor data that may be used to determine when to output a financial push notification associated with a microtask. As an example, a wearable may provide biometric data about the user that may be used to determine that the user is in an optimal or suboptimal physical or emotional state to address a microtask. Further, a user device may provide location data that may be used to determine when a user is in a good location to address a microtask. In at least one example, application data from applications on the user's device may be used to determine when to output a suggested action to the user device. In some examples, such information received from the user, the user device, or otherwise, may be used with a trained model to determine the best time to output a microtask to the user.

In some examples, the task may be associated with multiple users, such that the systems and methods disclosed herein involve providing the same or different microtasks associated with the task to different users. For example, in some situations multiple users may be sharing expenses, collaborating on a project, planning a trip together, a combination of these, or the like. In such instances, one or more of the microtasks may be relevant to more than one of the users. In some examples, a given microtask may have different suggested actions for different users that are part of the same overarching financial task. In at least one example, the suggested action or microtask is adjusted for each user based on the given user's user device(s). In at least one example, the systems and techniques described herein further involve determining to which user device to send the financial push notification based on the type of user devices associated with the user, the user devices currently with the user, the time of day, a user's schedule, sensor data from one or more of the user's user devices, application data from one or more of the user's user devices, a location of the user, a combination of these, or the like. In at least one example, the systems and methods involve sending different versions of the suggested action to multiple user devices belonging to a single user, the different versions corresponding to the different type of user interfaces of the user devices, for example, sending a more concise version of the suggested action to a smartwatch than to a smartphone of the user.

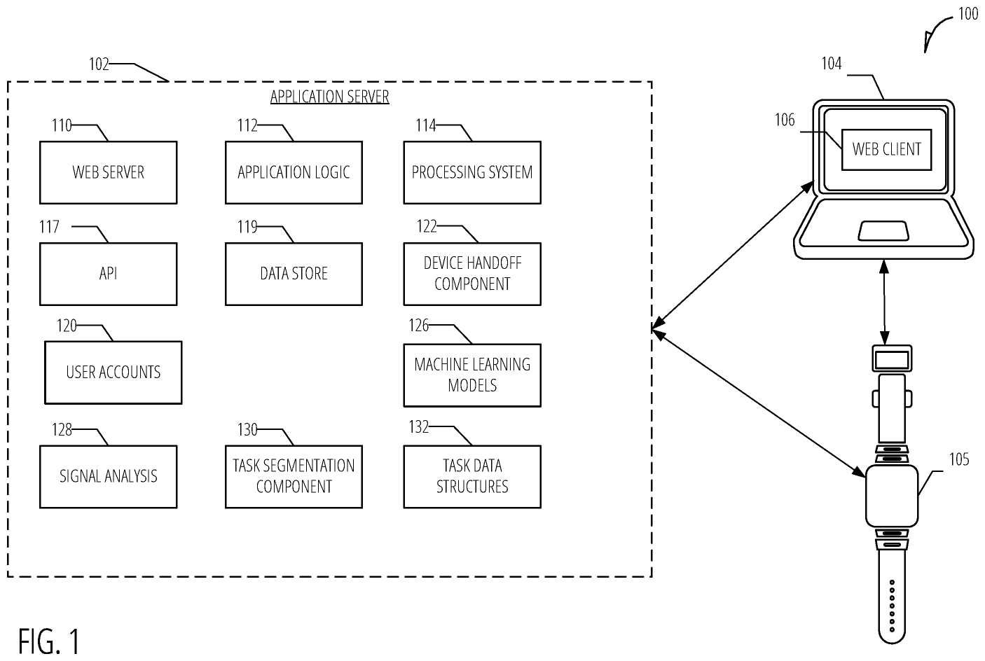

FIG. 1 is an illustration 100 of components of an application server and client devices, according to various examples. Application server 102 illustrates web server 110, application logic 112, processing system 114, application programming interface (API 117), data store 119, device handoff component 122, user accounts 120, machine learning models 126, signal analysis 128, task segmentation component 130, and task data structures 132.

Application server 102 is illustrated as set of separate elements (e.g., component, logic, etc.). However, the functionality of multiple, individual elements may be performed by a single element. An element may represent computer program code that is executable by processing system 114. The program code may be stored on a storage device (e.g., data store 119) and loaded into a memory of the processing system 114 for execution. Portions of the program code may be executed in a parallel across multiple processing units (e.g., a core of a general-purpose computer processor, a graphical processing unit, an application specific integrated circuit, etc.) of processing system 114. Execution of the code may be performed on a single device or distributed across multiple devices. In some examples, the program code may be executed on a cloud platform (e.g., MICROSOFT AZURE® and AMAZON EC2®) using shared computing infrastructure.

Client device 104 (and client device 105) may be a computing device which may be, but is not limited to, a smartphone, tablet, laptop, multi-processor system, microprocessor-based or programmable consumer electronics, game console, set-top box, or other device that a user utilizes to communicate over a network. In various examples, a computing device includes a display module (not shown) to display information (e.g., in the form of specially configured user interfaces). In some embodiments, computing devices may comprise one or more of a touch screen, camera, keyboard, microphone, or Global Positioning System (GPS) device.

Client device 104, client device 105, and application server 102 may communicate via a network (not shown). The network may include local-area networks (LAN), wide-area networks (WAN), wireless networks (e.g., 802.11 or cellular network), the Public Switched Telephone Network (PSTN) Network, ad hoc networks, cellular, personal area networks or peer-to-peer (e.g., Bluetooth®, Wi-Fi Direct), or other combinations or permutations of network protocols and network types. The network may include a single Local Area Network (LAN) or Wide-Area Network (WAN), or combinations of LAN's or WAN's, such as the Internet. In various examples, client device 104 and client device 105 may communicate over a peer-to-peer network while client device 104 and client device 105 may communicate with application server 102 over a long-range network connection (e.g., cellular, WAN).

In some examples, the communication may occur using an application programming interface (API) such as API 117. An API provides a method for computing processes to exchange data. A web-based API (e.g., API 117) may permit communications between two or more computing devices such as a client and a server. The API may define a set of HTTP calls according to Representational State Transfer (RESTful) practices. For examples, A RESTful API may define various GET, PUT, POST, DELETE methods to create, replace, update, and delete data stored in a Database (e.g., data store 119)

APIs may also be defined in frameworks provided by an operating system (OS) to access data in an application that an application may not regularly be permitted to access. For example, the OS may define an API call to obtain the current location of a mobile device (e.g., client device 105) the OS is installed on. In another example, an application provider may use an API call to request a be authenticated using a biometric sensor on the mobile device. By segregating any underlying biometric data—e.g., by using a secure element—the risk of unauthorized transmission of the biometric data may be lowered.

Application server 102 may include web server 110 to enable data exchanges with client device 104 via web client 106. Although generally discussed in the context of delivering webpages via the Hypertext Transfer Protocol (HTTP), other network protocols may be utilized by web server 110 (e.g., File Transfer Protocol, Telnet, Secure Shell, etc.). A user may enter in a uniform resource identifier (URI) into web client 106 (e.g., the INTERNET EXPLORER® web browser by Microsoft Corporation or SAFARI® web browser by Apple Inc.) that corresponds to the logical location (e.g., an Internet Protocol address) of web server 110. In response, web server 110 may transmit a web page that is rendered on a display device of a client device (e.g., a mobile phone, desktop computer, etc.).

Additionally, web server 110 may enable a user to interact with one or more web applications provided in a transmitted web page. A web application may provide user interface (UI) components that are rendered on a display device of client device 104. The user may interact (e.g., select, move, enter text into) with the UI components, and, based on the interaction, the web application may update one or more portions of the web page. A web application may be executed in whole, or in part, locally on client device 104. The web application may populate the UI components with data from external sources or internal sources (e.g., data store 119) in various examples.

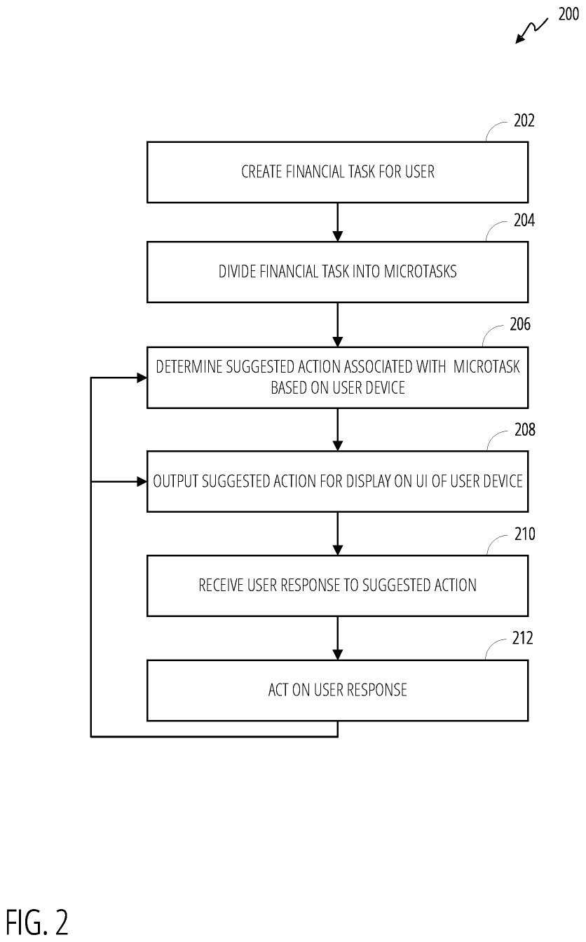

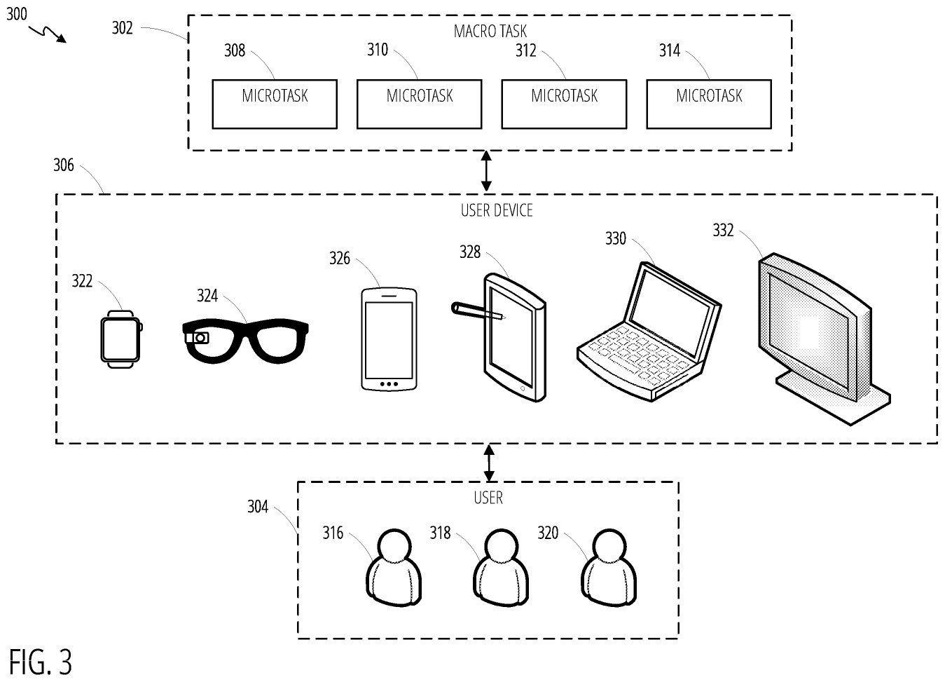

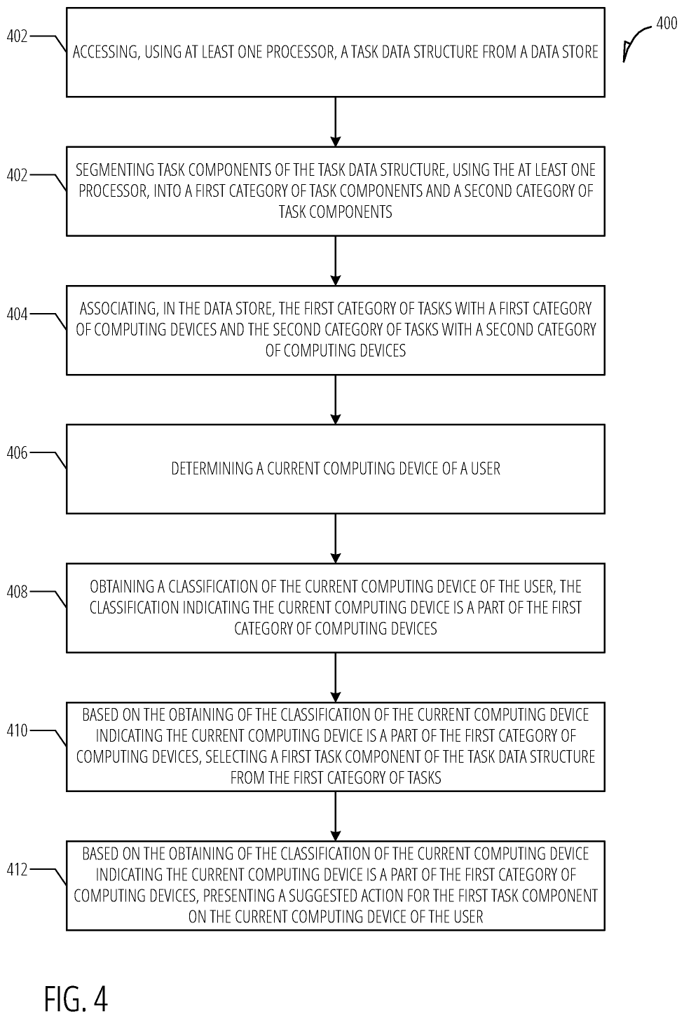

The web application may be executed according to application logic 112. Application logic 112 may use the various elements of application server 102 to implement the web application. For example, application logic 112 may issue API calls to retrieve or store data from data store 119 and transmit it for display on client device 104. Similarly, data entered by a user into a UI component may be transmitted using API 117 back to the Web Server. Application logic 112 may use other elements of FIG. 1 of application server 102 to perform functionality associated with the web application as described further herein. In various examples the web application provides user interfaces for display and retrieval of data as discussed in further detail with respect to FIG. 2, FIG. 3, and FIG. 4.

Data store 119 may store data that is used by application server 102. Data store 119 is depicted as singular element but may in actuality be multiple data stores. The specific storage layout and model used in by data store 119 may take a number of forms—indeed, a data store 119 may utilize multiple models. Data store 119 may be, but is not limited to, a relational database (e.g., SQL), non-relational database (NoSQL) a flat file database, object model, document details model, graph database, shared ledger (e.g., blockchain), or a file system hierarchy. Data store 119 may store data on one or more storage devices (e.g., a hard disk, random access memory (RAM), etc.). The storage devices may be in standalone arrays, part of one or more servers, and may be located in one or more geographic areas.

User accounts 120 may include user profiles on users of application server 102. A user profile may include credential information such as a username and hash of a password. A user may enter in their username and plaintext password to a login page of application server 102 to view their user profile information or interfaces presented by application server 102 in various examples.

A user account may also identify computing devices (e.g., client device 104 and client device 105) associated with the user. For example, a user may register one or more phones, desktop computers, tablets, or laptops with application server 102. Registering may include authorizing application server 102 to retrieve data and analyze (e.g., via signal analysis 128) such as location data, browser history, etc., from these devices. A user may revoke access to any such data at any time by updating their user profile. The data may be gathered via an application installed on one of the registered devices such as by downloading an application from an app store associated with the platform of their mobile phone.

Device handoff component 122 may include instructions for transitioning task completion from a first device to a second device. For example, a notification may be transmitted to a small form-factor device (e.g., a smart watch) with an action item related to the task that is better suited a device with a larger display. Device handoff component 122 may track an identification of the task for which the notification pertains or embed the identification as part of the transmitted notification (e.g., as part of a deep link//taskapp/312233). If a user clicks on the notification, device handoff component 122 may respond by transmitting a notification to the second device with the larger display to complete the task.

Task data structures 132 may be stored in data store 119 and have a plurality of components. These components may include, but are not limited to, identification of input devices for completing the task, shared status (e.g., is the task for one person or multiple), screen size preference for completing the task, privacy settings, time of day for completing the task, etc. A task may be divided into microtasks by task segmentation component 130. Additional details with respect to the function of these components is provided in the context of FIG. 2.

FIG. 2 illustrates a flowchart showing a method for providing push notifications for microtasks, according to various examples. The tasks below are described in the context of financial use cases, but the methods are not limited to such use cases. In an example, operations of the method 200 may be performed by processing circuitry such as those illustrated and described with reference to FIG. 1.

At block 202, the application server 102 creates a financial task for the user and stores it as a task data structure (e.g., task data structures 132). The financial task may be selected by the user (via the client device 104 or otherwise), generated based on user information, or otherwise created. In at least one example, the financial task involves multiple users. The financial task may be any task that the user needs to address that is associated with finances, for example, reviewing or maintaining a budget, planning travel, reviewing investments or performance, scheduling expenses, managing accounts, planning a trip, collaborating on a project, planning an event, shared expenses, a combination of these, or the like.

At block 204, task segmentation component 130 divides the financial task into one or more microtasks that are smaller tasks that are part of or otherwise help accomplish the overall financial task. In at least one example, task segmentation component 130 selects the microtasks based on the type of a user device. For example, a financial task might be divided into a greater number of smaller microtasks for client device 105 that is a smartwatch client device 104 that is a smart phone, since more information can reasonably be displayed or addressed on a smart phone than a smartwatch. However, in other examples, the microtasks are not selected based on the type of device. In some examples, the microtasks are determined based on user-provided input.

In some examples, the microtasks are determined based on a machine learning trained model (e.g., machine learning models 126). For example, a supervised training model (e.g., k-nearest neighbor, logistical regression, neural network) may be trained using what type of device users have used in the past to complete a task.

As an example, a financial task of reviewing or maintaining a user's budget may be divided into microtasks based on individual budget categories, or even individual expenses, such that instead of reviewing an entire budget, the user only reviews or edits small pieces of the budget at a time. As another example, a financial task of a group project may be divided into microtasks based on a schedule of what needs to be done, based on purchases that need to be made, based on each user's responsibilities, a combination of these, or the like. As such, each user may not be assigned to or otherwise associated with every microtask.

At block 206, processing system 114 determines a suggested action associated with a microtask of the one or more microtasks based on the type of user device that the microtask is going to be transmitted to. That is, the suggested action may be different for a small form device than a device with a larger user interface. For example, the suggested action for a smartwatch would likely not include viewing large documents or reading long text. In some examples, the microtasks, rather than the suggested actions are determined based on the type of device. In at least one example, both the microtasks and the suggested action are determined based on the type of device. The suggested action may further be determined based on user input, user information, user status, user location, time of day, biometric data of the user, application information from the user's device, a machine learning trained model, a combination of these, or the like.

In some examples, the suggested action may be a reminder or notification about the microtask. In other examples, the suggested action may provide options for the user to select to address the microtask or to dismiss the suggested action. In some examples, the suggested action may provide options to vote or select how to respond or address the microtask. In some examples, the suggested action may provide suggestions for communication with other users associated with the financial task. In at least one example, the suggested action provides options for chat, voice, or video communication to address the microtask. In at least one example, the suggested action may be a summary (e.g., reflection of the day, expenses, accomplishments, etc.). In some examples, the suggested action may be a reminder to acknowledge accomplishments (e.g., staying within budget, completing microtasks, etc.). In at least one example, the suggested action may include a checklist, chart, graph, or other organized information suitable for a small form device. In some examples the suggested action may provide image, text, audio, links, options to be selected by a user, a combination of these, or the like suitable for a small form device.

In some examples, the suggested action may include a link to provide additional information or handle additional aspects of the microtask on a second device. In at least one example, the systems and methods provide a smart handoff between the first and second user devices (e.g., using device handoff component 122). For example, a first device may be a small form device such as a smartwatch, and the second device may be a device with a larger display, such as a smartphone, tablet, or computer. As one example, the suggested actions on the smaller user device may be used to track budget goals in a concise manner, but link to an application or website where the user may view the overall budget information on a larger device.

In another example, the suggested action may include reminders about microtasks that need to be completed, but the overall checklist of microtasks may be provided on the larger device. In yet another example, the suggested action may provide a chart or other concise depiction of progress on a project or microtask, and the larger device may provide further details on the progress. In some examples, the suggested action may allow the user to initiate a transaction (e.g., a bank transfer), that is then finished on the larger device (e.g., by electronic signature). In some examples, the suggested action may be a notification to address a microtask which links to the larger device where the user may see more details and perform the task. In some examples, the suggested action may be a quick way to address the microtask (e.g., yes/no answer, quick selection, etc.) but may provide a link to view more details on the larger device.

At block 208, the method includes presenting the suggested action for display on a user interface a client device. In some examples, the client device a small form device such as a wearable, and the suggested action is suitable for display on the user interface of the small form device. In some examples, the suggested action provided to the client device may include text, image(s), options for user selection, links, audio, a combination of these, or the like.

In some examples, application logic 112 decides to output the suggested action (which suggested action and when) based on user information, user input, sensor data from one or more registered client devices, a user's schedule, time of day, information from one or more applications on the user's device(s), a combination of these, or the like. As an example, if sensor data, the user's schedule, user input, etc. indicates that the user is commuting (e.g., based on the output of a machine learning model), application logic 112 may decide to output suggested actions to a small form user device (such as a smartwatch) rather than a larger user device (such as a smart phone). As another example, if sensor data, a user's schedule, user input, etc. indicates that the user is in a meeting, application logic 112 does not output suggested actions to avoid disturbing the user, but if the sensor data, user's schedule, user input, etc. indicates that the user has a break between meetings, application logic 112 may decide to output a time-appropriate suggested action during the break between meetings. In at least one example, if sensor data, application data, user input, etc. suggests that the user is in a crowd (e.g., commuting on public transportation or standing in a crowded space), application logic 112 will avoid sending sensitive or private suggested actions (or suggested actions associated with sensitive or private topics). In some examples, if sensor data, application data, user input, etc. indicates that the user is with their spouse (or other user(s) that shares the same microtasks), application logic 112 may output suggested actions (to the user device(s) of one or both users) that affect or require both users.

As an additional example, if sensor data, application data, user input, etc. indicates that the user is at a store at which items can be purchased to address a microtask, application logic 112 may output a suggested action associated with that microtask that reminds the user to purchase the items. In some examples where the microtask is part of a financial task associated with multiple users, application logic 112 may further output suggested actions to the other users to send their share of payment to purchase the items, to ask you to purchase items for them, or the like. For example, if the financial task is planning an event and the first user is at a party store, application logic 112 may present a suggested action to the first user to accomplish their microtask of purchasing plates, present to a second user a suggested action to send money to the first user to accomplish the second user's microtask of purchasing tablecloths, and send a suggested action to a third user to send money to the first user to accomplish the third user's microtask of purchasing decorations. In this example, the suggested actions to the second and third users may include options for the second and third users to select, such as “send money”, “contact first user”, “already purchased”, “not now”, a combination of these or the like.

Some examples may include a temporal aspect, such as providing a timer for the second and third users to respond to the suggested action, which may be an amount of time provided by the first user to indicate how much longer they will be in the party store. In another example, application data, sensor data, schedule data, user input, etc. may indicate that the first user is on their way to the party store and how long until they will be there (e.g., user enters the party store into a map application for directions), and application logic 112 may send suggested actions to the second and third users to let them know that the first user will be at the party store soon.

In some examples, if sensor data, a user's schedule, user input, etc. indicates that a user is walking or driving, application logic 112 may output one or more suggested actions that do not require signification cognitive overhead, that do not require looking at a screen, etc. In such examples, application logic 112 may output one or more audio suggested actions. In at least one example, application logic 112 may output suggested actions based on the time of day, for example providing more complex suggested actions in the morning and suggested actions that are easier to address later in the day when the user is likely more mentally exhausted.

In some examples, user input or preferences can be used to determine what type of suggested actions to send at what time of day. In at least one example, application data, user input, sensor data, etc. may indicate that the user is in a particular emotional or physical state that is optimal for addressing one or more suggested actions. For example, the user is listening to their favorite song, the user is at their resting heartrate but attentive, or the like that may indicate to the application logic 112 that it is a good time to output one or more suggested actions. Similarly, application data, user input, sensor data, etc. may indicate that the user is in a suboptimal emotional or physical state for receiving one or more suggested actions. As an example, biometric sensor data (racing heartbeat, pupil dilation, starry eyes, voice stress levels, blood alcohol level, etc.) may indicate that the user should avoid suggested actions or microtasks that might be negatively affected by impulsivity. Similarly, such biometric sensor data (or other similar information from other sources) may cause the application logic 112 decide to present one or more suggested actions to prevent impulsive behavior (for example, spending that will negatively affect a financial task).

In some examples, application information from a client device may be used by the application logic 112 to determine when to send a suggested action. Examples of application information include, a location entered or saved in a map application, information about homes of interest in a home buying application, saved items, coupons, sales, or other savings from store applications, fitness or exercise tracking information from exercise applications, schedules from calendar applications, etc. In various examples, application logic 112 may use a machine learning trained model to determine when to send suggested actions to the user. The model may be trained based on user input, user selections responsive to suggested actions, user information, sensor data from one client devices, the user's schedule, time of day, information from one or more applications on the user's device(s), a combination of these, or the like.

At block 210, application logic 112 receives (for example, via a network) a user response to the suggested action. In some examples, the user response may be selection of an option provided in the suggested action, selecting a link provided in the suggested action, dismissing the suggested action, a combination of these, or the like. In some examples the user response may be provided via the user interface of the user device, via audio input, by failing to make a selection in a certain amount of time, etc.

At block 212, application logic 112 acts on the user response. In some examples, the user response addresses the microtask such that the application logic 112 can mark the microtask as completed. In some examples, the application logic 112 notes that the suggested action will need to be provided at another time, or that the microtask still needs to be addressed. In some examples, based on the user response, the application logic 112 may decide to output a subsequent suggested action to the user or other users for the same or related microtasks.

In some examples, following block 212 the method 200 returns to block 206 to determine suggested actions for subsequent microtasks of the one or more microtasks associated with the financial task. In some examples, following block 212, the method 200 returns to block 208 to present the suggested action for display on a user interface of the client device (e.g., if the suggested action was dismissed or the microtask was not fully addressed). In some examples, the method 200 ends as a result of all of the microtasks having been addressed.

FIG. 3 illustrates general components of a push notification framework, according to various examples. The block diagram 300 illustrates the financial task 302 (e.g., as stored as part of task data structures 132) associated with a user 304 via the user device 306. In the illustrated example, the financial task has been divided into a plurality of microtasks 308, 310, 312, 314. In other examples, any given financial task 302 may be divided into more or fewer microtasks 308, 310, 312, 314 than shown in the illustrated example.

In some examples a single user 304 is associated with the financial task 302, while in other examples a plurality of users 316, 318, 320 may be associated with the financial task. In such examples, any given user 304 of the plurality of users 316, 318, 320 may be assigned one or more of the microtasks 308, 310, 312, 314 as appropriate. Further, different users 316, 318, 320 may receive the same or different suggested actions for the same microtask 308, and the suggested actions may be outputted to the respective users 316, 318, 320 at the same or different times. Since different users 316, 318, 320 may have different user devices 306, different applications, different schedules, different user preferences/inputs, different sensors and sensor data, etc., in some examples or at some times the processor may decide to output suggested actions individually for each user 316, 318, 320. In some examples, the processor may decide to output suggested actions to multiple users 316, 318, 320 at the same time for related microtasks when users 316, 318, 320 are together, based on a time requirement, based on one user's information or status (e.g., the example where the first user 316 is going to the party store), a combination of these, or the like.

The user device 306 may be any of a variety of user devices 306, such as a smartwatch 322, smart glasses 324, a smart phone 326, a tablet 328, a laptop 330, a personal computer 332, a different wearable or small form device, or another user device. In some examples, the systems and techniques for providing financial push notification for microtasks are specific to small form user devices. In some examples, a user 304 may have more than one user device, such that while the suggested action may be sent to a first small form user device 306 of the user 304 (e.g., the smartwatch 322) the suggested action may include links or otherwise include a smart handoff to a larger second user device 306 (e.g., the smart phone 326). In some examples, the user 304 may set user preferences for which devices are to be used for suggested actions and smart handoffs.

Embodiments described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium.

In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

FIG. 4 is a flowchart illustrating a method for presenting suggested actions, according to various examples. The method is represented as a set of blocks that describe operation 402 to operation 412 of method 400. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processors that execute the set of instructions to configure the one or more processors to perform the operations illustrated in FIG. 4. The one or more processors may instruct other component of the computing device(s) to carry out the set of instructions. For example, the computing device may instruct a network device to transmit data to another computing device or the computing device may provide data over a display interface to present a user interface. In some examples, performance of the method may be split across multiple computing devices using a shared computing infrastructure.

At operation 402, in various examples, method 400 includes accessing, using at least one processor, task data structure from a data store. For example, periodically (e.g., hourly) a system such as application server 102 may access task data structures 132. Application logic 112 may retrieve a task that has not yet been divided into microtasks.

At operation 404, in various examples, method 400 includes segmenting task components (e.g., microtasks) of the task data structure (e.g., using task segmentation component 130), into a first category of task components and a second category of task components. The categories may be determined according to characteristics (e.g., required screen size, input device, location, privacy) of the task components as stored in the data structure.

In various examples, the first category of computing devices is defined as including computing devices having a display size below a threshold and the second category of computing devices is defined as including computing device at or above the threshold. In various examples, the first category of computing devices is defined as including wearable computing devices and the second category of computing devices is defined as excluding wearable computing devices. In various examples, the first category of computing devices is defined as including computing devices having a processor of a first instruction architecture (X86) and the second category of computing devices is defined as having a processor of a second instruction architecture (ARM). In various examples, the first category of computing devices is defined as including computing devices having a first type of input device and the second category of computing devices is defined as not having the first type of input device.

At operation 406, in various examples, method 400 includes associating, in the data store, the first category of tasks with a first category of computing devices and the second category of tasks with a second category of computing devices. Associating may include update a database entry to identify a subset of registered computing devices in a user account with the first category or tasks and a different subset of registered computing device with the second category of tasks.

At operation 408, in various examples, method 400 includes determining a current computing device of a user. The current computing device may be determined based on a most recent communication from a computing device of the user. For example, if the user has viewed tasks on their smart phone, the smart phone may be flagged (e.g., a database entry may be updated) to indicate the smart phone is the current computing device.

At operation 410, in various examples, method 400 includes based on the obtaining of the classification of the current computing device indicating the current computing device is a part of the first category of computing devices, selecting a first task component of the task data structure from the first category of tasks. At operation 412, in various examples, method 400 includes based on the obtaining of the classification of the current computing device indicating the current computing device is a part of the first category of computing devices, presenting a suggested action for the first task component on the current computing device of the user.

In various examples, method 400 may also include receiving a user input from the current computing device in response to the suggested action, and responsive to the user input, presenting additional information associated with the first task component on a second computing device where the second computing device has a bigger display than the current computing device.

In various examples, method 400 may also include accessing location data from the current computing device and determining when to present the suggested action based on the location data of the current computing device. For example, if the location indicates the user is moving at a rate of speed above 3 mph, it may be inferred the user is travelling and choose not to present the suggested action at that time. In various examples, method 400 may also include accessing biometric data (e.g., heart rate) of the user from the current computing device and determining when to present the suggested action based on the biometric data (e.g., if the heart rate is above a threshold, do not present at that time).

In various examples, method 400 may also include determining a second current computing device of the user and obtaining a classification of the second current computing device of the user. The classification may indicate the second current computing device is a part of the second category of computing devices. And, based on the obtaining of the classification of the second current computing device indicating the second current computing device is a part of the second category of computing devices, the method may include selecting a second task component of the task data structure from the second category of tasks. The method may further include presenting a suggested action for the second task component on the second current computing device of the user.

In various examples, method 400 may include generating a feature vector where each element of the feature vector corresponds to an aspect (e.g., screen size, processing speed, operation system) of the current computing device. The feature vector may be inputted into a machine learning model. An output vector may be received from the machine learning model, where each element of the output vector corresponds to a potential action, and based on the output vector, selecting the suggested action.

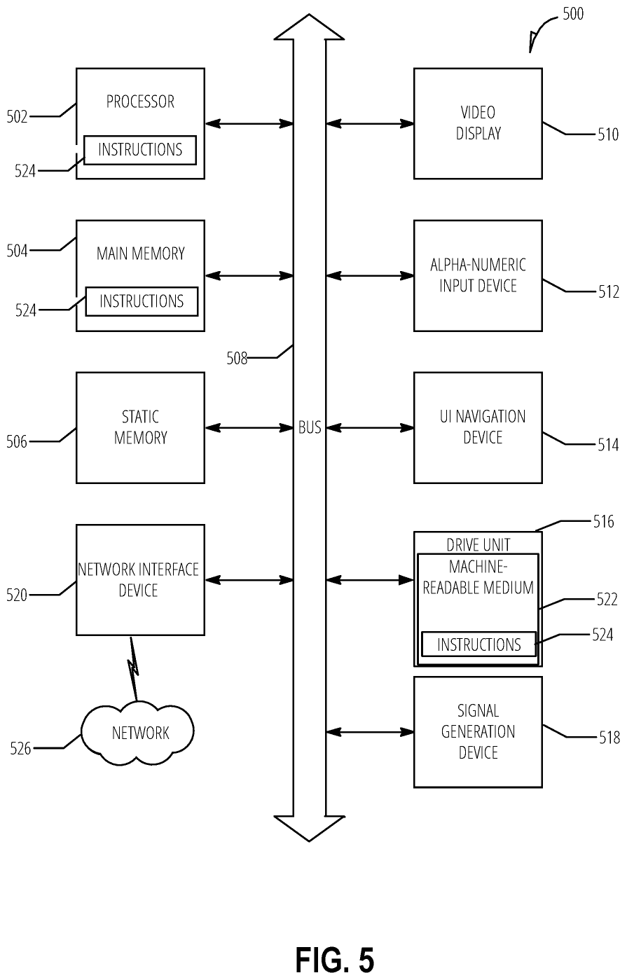

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 May also reside, completely or at least partially, within the main memory 504, static memory 506, and/or within the processor 502 during execution thereof by the computer system 500, with the main memory 504, static memory 506, and the at least one processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, 4G LTE/LTE-A or WiMAX networks, and 5G). The term “transmission medium” shall be taken to include any intangible medium that is capable of storing, encoding, or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

1. A method comprising:
accessing, using at least one processor, a task data structure from a data store, the task data structure comprising a plurality of task components, where a task component includes dependencies on other task components;
accessing, using the at least one processor, a set of computing devices from the data store;
determining computational aspects for a computing device from the set of computing devices;
defining a first classification of computing devices having a first set of computational aspects, and a second classification of computing devices having a second set of computational aspects, wherein the first set of computational aspects are different from the second set of computational aspects;
segmenting task components of the task data structure, using the at least one processor, into a first category of task components and a second category of task components, wherein segmenting task components includes analyzing the dependencies for a task component and the computational aspects for the computing device;
associating, in the data store, the first category of tasks with the first classification of computing devices and the second category of tasks with the second classification of computing devices, wherein associating comprises updating a database entry to identify a subset of computing devices in a user account with the first category of tasks and a different subset of computing devices with the second category of tasks;
determining a current computing device of a user;
obtaining computational aspects of the current computing device of the user
inputting the computational aspects of the current computing device of the user into a machine learning model;
determining, based on the computational aspects of the current computing device, that the current computing device is part of the first classification of computing devices; and
based on the determination that the current computing device is part of the first classification of computing devices:
selecting a first task component of the task data structure from the first category of tasks; and
receiving a first output from the machine learning model including a suggested action for the first task component on the current computing device of the user.

2. The method of claim 1, further comprising, at a time subsequent to the receiving:
determining a second current computing device of the user;
obtaining computational aspectes of the second current computing device of the user
inputting the computational aspects of the second current computing device of the user into a machine learning model;
determining, based on the computational aspects of the second current computing device, that the second current computing device is part of the second classification of computing devices; and
based on the determination that the second current computing device is part of the second classification of computing devices:
selecting a second task component of the task data structure from the second category of tasks; and
receiving a second output from the machine learning model including a suggested action for the second task component on the second current computing device of the user.

3. The method of claim 1, further comprising:
receiving a user input from the current computing device in response to the suggested action.

4. The method of claim 3, further comprising:
responsive to the user input, presenting additional information associated with the first task component on a second computing device, wherein the second computing device has a bigger display than the current computing device.

5. The method of claim 1, further comprising:
accessing location data from the current computing device; and
determining when to present the suggested action based on the location data of the current computing device.

6. The method of claim 1, further comprising:
accessing biometric data of the user from the current computing device; and
determining when to present the suggested action based on the biometric data.

7. The method of claim 1, further comprising:
generating a feature vector, wherein each element of the feature vector corresponds to an aspect of the current computing device;
inputting the feature vector into a machine learning model;
receiving an output vector from the machine learning model, wherein each element of the output vector corresponds to a potential action; and
based on the output vector, selecting the suggested action.

8. The method of claim 1, wherein the first classification of computing devices is defined as including computing devices having a display size below a threshold and the second classification of computing devices is defined as including computing device at or above the threshold.

9. The method of claim 1, wherein the first classification of computing devices is defined as including wearable computing devices and the second category of computing devices is defined as excluding wearable computing devices.

10. The method of claim 1, wherein the first classification of computing devices is defined as including computing devices having a processor of a first instruction architecture and the second classification of computing devices is defined as having a processor of a second instruction architecture.

11. (canceled)

12. A non-transitory computer-readable medium comprising instructions, which when executed by at least one processor, configure the at least one processor to perform operations comprising:
accessing a task data structure from a data store, the task data structure comprising a plurality of task components, where a task component includes dependencies on other task components;
accessing, using the at least one processor, a set of computing devices from the data store;
determining computational aspects for a computing device from the set of computing devices;
defining a first classification of computing devices having a first set of computational aspects, and a second classification of computing devices having a second set of computational aspects, wherein the first set of computational aspects are different from the second set of computational aspects;
segmenting task components of the task data structure into a first category of task components and a second category of task components, wherein segmenting task components includes analyzing the dependencies for a task component and the computational aspects for the computing device;
associating, in the data store, the first category of tasks with the first classification of computing devices and the second category of tasks with the second classification of computing devices, wherein associating comprises updating a database entry to identify a subset of computing devices in a user account with the first category of tasks and a different subset of computing devices with the second category of tasks;
determining a current computing device of a user;
obtaining computational aspects of the current computing device of the user
inputting the computational aspects of the current computing device of the user into a machine learning model;
determining, based on the computational aspects of the current computing device, that the current computing device is part of the first classification of computing devices; and
based on the determination that the current computing device is part of the first classification of computing devices:
selecting a first task component of the task data structure from the first category of tasks; and
receiving a first output from the machine learning model including a suggested action for the first task component on the current computing device of the user.

13. The non-transitory computer-readable medium of claim 12, further comprising instructions, which when executed by the at least one processor, configure the at least one processor to perform operations comprising, at a time subsequent to the receiving:
determining a second current computing device of the user;
obtaining computational aspects of the second current computing device of the user
inputting the computational aspects of the second current computing device of the user into a machine learning model;
determining, based on the computational aspects of the second current computing device, that the second current computing device is part of the second classification of computing devices; and
based on the determination that the second current computing device is part of the second classification of computing devices:
selecting a second task component of the task data structure from the second category of tasks, wherein the first classification of computing devices is defined as including computing devices having a first type of input device and the second classification of computing devices is defined as not having the first type of input device; and
receiving a second output from the machine learning model including a suggested action for the second task component on the second current computing device of the user.

14. The non-transitory computer-readable medium of claim 12, further comprising instructions, which when executed by the at least one processor, configure the at least one processor to perform operations comprising:
receiving a user input from the current computing device in response to the suggested action.

15. The non-transitory computer-readable medium of claim 14, further comprising instructions, which when executed by the at least one processor, configure the at least one processor to perform operations comprising:
responsive to the user input, presenting additional information associated with the first task component on a second computing device, wherein the second computing device has a bigger display than the current computing device.

16. The non-transitory computer-readable medium of claim 12, further comprising instructions, which when executed by the at least one processor, configure the at least one processor to perform operations comprising:
accessing location data from the current computing device; and
determining when to present the suggested action based on the location data of the current computing device.

17. The non-transitory computer-readable medium of claim 12, further comprising instructions, which when executed by the at least one processor, configure the at least one processor to perform operations comprising:
accessing biometric data of the user from the current computing device; and
determining when to present the suggested action based on the biometric data.

18. The non-transitory computer-readable medium of claim 12, further comprising instructions, which when executed by the at least one processor, configure the at least one processor to perform operations comprising:
generating a feature vector, wherein each element of the feature vector corresponds to an aspect of the current computing device;
inputting the feature vector into a machine learning model;
receiving an output vector from the machine learning model, wherein each element of the output vector corresponds to a potential action; and
based on the output vector, selecting the suggested action.

19. The non-transitory computer-readable medium of claim 12, wherein the first classification of computing devices is defined as including computing devices having a display size below a threshold and the second category classification of computing devices is defined as including computing device at or above the threshold.

20. A system comprising:
at least one processor; and
storage device comprising instructions, which when executed by the at least one processor, configure the at least one processor to perform operations comprising:
accessing a task data structure from a data store, the task data structure comprising a plurality of task components, where a task component includes dependencies on other task components;
accessing a set of computing devices from the data store;
determining computational aspects for a computing device from the set of computing devices;
defining a first classification of computing devices having a first set of computational aspects, and a second classification of computing devices having a second set of computational aspects, wherein the first set of computational aspects are different from the second set of computational aspects;
segmenting task components of the task data structure into a first category of task components and a second category of task components, wherein segmenting task components includes analyzing the dependencies for a task component and the computational aspects for the computing device;
associating, in the data store, the first category of tasks with the first classification of computing devices and the second category of tasks with the second classification of computing devices, wherein associating comprises updating a database entry to identify a subset of computing devices in a user account with the first category of tasks and a different subset of computing devices with the second category of tasks;
determining a current computing device of a user;
obtaining computational aspects of the current computing device of the user
inputting the computational aspects of the current computing device of the user into a machine learning model;
determining, based on the computational aspects of the current computing device, that the current computing device is part of the first classification of computing devices; and
based on the determination that the current computing device is part of the first classification of computing devices:
selecting a first task component of the task data structure from the first category of tasks; and
receiving a first output from the machine learning model including a suggested action for the first task component on the current computing device of the user.
